(19) United States
(12) Patent Application Publication
(10) Pub. No.: US 2025/0269324 A1
(43) Pub. Date: Aug. 28, 2025

(54) GEOCATALYSTS AND THEIR APPLICATION TO CONTROL CO2 CAPTURE PROCESSES, ECONOMICALLY AND WITH ENVIRONMENTAL BENEFITS

(71) Applicant: Danmarks Tekniske Universitet, Kongens Lyngby (DK)

(72) Inventors: Susan Louise Svane STIPP, Kongens Lyngby (DK); Henning Friis POULSEN, Kongens Lyngby (DK); Stina Bjerg NIELSEN, Kongens Lyngby (DK)

(21) Appl. No.: 18/859,569

(22) PCT Filed: Apr. 24, 2023
(86) PCT No.: PCT/EP2023/060644

§ 371 Date: Oct. 24, 2024

(30) Foreign Application Priority Data
Apr. 25, 2022 (EP) 22169705.5

(51) Int. Cl. B01D 53/62

(52) U.S. Cl. CPC B01D 53/62; B01D 2251/606; B01D 2257/504; B01D 2258/0233; B01D 2258/0283

(57) ABSTRACT

The application of geocatalysts in controlling CO₂ capture processes in situ as well as in a reaction vessel, chamber or tower is described. More specifically, a process for controlling the reaction of a CO₂-containing gas stream with one or more starting materials selected from waste building material, mineral, rock, sand, amorphous material or combinations thereof is disclosed: wherein said starting material comprises Si and/or Al, and one or more divalent cation(s), water, and one or more organic compound(s) to control the reaction: thereby providing a product comprising: at least one carbonate mineral and preferably colloidal silica.

### TECHNICAL FIELD

The present invention relates to geocatalysts and their application to control natural CO₂ capture processes in situ as well as in a reaction vessel, chamber or tower. More specifically, the invention relates to a process for controlling the reaction of a CO₂-containing gas stream with one or more starting materials selected from waste building material, mineral, rock, sand, amorphous material or combinations thereof; wherein said starting material comprises Si and/or Al, and one or more divalent cation(s), water, and one or more organic compound(s) to control the reaction; thereby providing a product comprising: at least one carbonate mineral and preferably colloidal silica or alumina or aluminosilicates.

### BACKGROUND

Carbon dioxide (CO₂) has been long known to contribute to global warming and ocean acidification. Human-caused activity has increased atmospheric CO₂ levels by at least 50% over pre-industrial levels. Most of the CO₂ is a by-product of burning fossil fuels, such as coal, oil and natural gas. Some results from production of cement.

Global efforts for reducing CO₂ emissions aim to improve energy efficiency, implement renewable, carbon-free energy sources and develop carbon capture and storage (CCS) solutions. Many efforts are focused on capturing CO₂ before it enters the atmosphere, transporting it and storing it for hundreds or thousands of years, where hopefully, it will transform back to minerals and rocks. Although CO₂ has been injected into geological formations for several decades for various purposes, such processes are relatively expensive, and yield no product or one that has low intrinsic value. However, CCS solutions, when combined with a utilization process to produce high-value chemicals or other products, using CO₂ to offset the high cost of capture operations, have gained interest in recent years.

Related technologies are described in WO2013/022896 and US2009/0301352.

Thus, there is a need for methods that are able to provide a local, cheap, fast and permanent mineralisation of CO₂, which provides significant environmental as well as economic benefits.

### SUMMARY

It is an object of the invention to provide a process for permanent CO₂ conversion to solids, which process utilizes geocatalysts in order to speed and control the reaction and to control the secondary phases, thus providing valuable products at a low economical cost.

In a first aspect, the present invention relates to a process for controlling the reaction of:
a CO₂-containing gas stream with
one or more starting materials selected from stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials, such as bricks or ceramics or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably
colloidal silica.

In a second aspect, the present invention relates to a process for controlling the reaction of:
a CO₂-containing gas stream with
one or more starting materials selected from andesitic, basic or ultrabasic rock; such as basalt, glass or basaltic glass, or sand (silt) or (volcanic) ash or the minerals of andesitic, basic and ultrabasic rocks or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably colloidal silica, wherein, the process is carried out in-situ, underground, in or on the ground.

Further aspects are evident in the enclosed claims, figures and description text.

### FIGURES

FIG. 1: A example process for controlling CO₂ capture in accordance with the invention

FIG. 2: Table comprising surface area and composition of example starting materials

FIG. 3: The fresh and reacted glass surface

FIG. 4: Glass alteration

FIG. 5: Glass reaction at high pH

FIG. 6: Secondary phases

FIG. 7: Chemical analysis of secondary phases

FIG. 8: Reaction of stone wool fibres

FIG. 9: An example of the behaviour of ligands

FIG. 10: An example of the effect of ligands on soluble silica

FIG. 11: An example of the effect of temperature on soluble silica

### DETAILED DISCLOSURE OF THE INVENTION

Accordingly, the inventors of present invention have identified an efficient process for permanent CO₂ capture, which process is controlled, fast and results in valuable products, which may be further used in e.g., the construction industry.

### Definitions

The term “in situ” is defined as the process occurring in nature, in a natural setting, in a rock formation or on the ground, for example, in the pores and fractures of a basaltic rock formation or in the pores of sand, gravel, soil or ash. The term “underground” is used to mean in the groundrock layer of the earth, below any soil layer

The term “ex situ” can refer to the same process taking place in a laboratory, or a factory, in a reaction vessel, using very fine grained a waste or natural materials as the starting materials.

The term “starting material” is any single material or mixture of materials, that is basic in nature, i.e. when exposed to water, the pH increases, and that has divalent cations, for example Ca, Mg or Fe(II) and it might or might not contain silicates or aluminosilicates.

The term “building materials” is defined as manufactured materials, that provide a specific function for buildings.

The term “CO₂ stream” refers to a gas, for example emitted from a chimney, that contains CO₂ in some proportion that is higher than in air, preferably at least 50 vol % CO₂, such as at least 75 vol % CO₂.

The term “CO₂ bearing water” refers to water that has been exposed to CO₂, and contains CO₂, regardless of its saturation state.

The term “mineralisation” is defined as the conversion of CO₂ in gaseous form, to CO₂ in solid form, such as a carbonate mineral.

The term “ash” is used to describe—inter alia—fly ash, coal ash, bottom ash, volcanic ash, wood ash and biofuel ash.

The term “biogenic” refers to organic compounds that are normally produced by a living organism, such as algae, bacteria or other suitable microorganisms, plants or animals. The biogenic compound may be naturally produced, i.e. obtained from the microorganism, plant or animal directly, however the biogenic organic compound may also be synthetically produced, e.g. in a laboratory setting, having the same composition and structure as the naturally produced analogue or alternatively a similar composition and structure as the naturally produced analogue.

The term “geocatalyst” refers to an organic compound which increases the rate of a chemical reaction, while the organic compound itself is not consumed in the reaction and remains unchanged after the reaction. In the context of the present invention, the term “geocatalyst” also refers to compounds that are able to increase the rate and/or extent of a reaction of a starting material comprising a silicon (i.e. a silicate) and/or aluminosilicate-containing mineral, rock, sand and/or amorphous material with a CO₂-containing gas stream in the presence of water, providing a product comprising at least one carbonate mineral and preferably colloidal silica or alumina or aluminosilicate. The geocatalyst can control the rate of the process, either to enhance reaction rate or to inhibit it.

The geocatalyst can also control the size, shape, composition and structure of the secondary phase(s) of the product. It is understood, that the geocatalyst might not be consumed during this reaction and that the geocatalyst can be recoverable from the reaction mixture. There are conditions where the organic compound might be trapped within growing crystals, making it unchanged after the reaction but no longer available for future reaction (until Ostwald ripening releases it again).

The term “biogenic geocatalyst” refers to an organic compound which increases the rate of a chemical reaction while the organic compound itself is not consumed in the reaction and remains unchanged after the reaction, which organic compounds are normally produced by a living organism and are obtained from a living organism or synthetically produced to provide the same composition and structure as the natural analogue or alternatively a similar composition and structure as the natural analogue.

The term “ligand” and/or “ligand with one or more functional groups” refer to organic compounds which have one or more functional groups which causes the organic compounds to undergo pairing, complexing or chelating with various ions e.g. in solution or on surfaces. Although most ligands are negatively charged, some can be positively charged.

The term “product” refers to the substances or end products, the secondary phases, that are present at the end of the process according to the claims. These may result from a single-step chemical reaction or may be the result of a multiple-step chemical reaction.

The term “leaching” refers to a process where a solute is detached or extracted from its carrier substance by way of a solvent. In the context of the invention, leaching is further defined as the removal of elements from a solid without congruent dissolution of the solid, leaving a leached layer on the solid. Leaching can be enhanced by geocatalysts.

The term “colloid” is defined as a microscopic particle. Although the upper limit defined for colloid diameter varies considerably over the scientific literature, depending on the material and the suspension medium used, in the context of this application, a colloid is understood to be a particle with a diameter less than or equal to 10 μm (micrometres), using the definition of McCarthy J. F. and Zachara J. M. (1989) Subsurface transport of contaminants. Environmental Science and Technology, 23, 496-502.

The term “pozzolanic” is defined as the ability of a material to produce a chemical reaction to bind materials together. In one aspect, the fine grained (colloidal) silica, alumina and/or aluminosilicates contribute to the pozzolanic effect of the product.

In a first embodiment, a process is provided for controlling the reaction of a CO₂-containing gas stream with one or more starting materials, water, and one or more organic compounds to control the reaction, thereby providing a product comprising at least one carbonate mineral and preferably colloidal silica, alumina or aluminosilicates. Preferably, the reaction comprises mineralization of CO₂.

In a second embodiment, an in situ process is provided for controlling the reaction of CO₂ containing water, injected into in situ natural materials, with one of more organic compounds to control the reaction, thereby permanently mineralising the CO₂, removing it from the Earth surface environment, or in a water cycling process, to produce a product comprising at least one carbonate mineral and preferably colloidal silica, alumina or aluminosilicates. Preferably, this reaction also comprises mineralisation of CO₂.

In one aspect, the reaction control comprises or consists of an increase or decrease in the dissolution rate and/or dissolution extent and/or leaching rate and/or leaching extent of the one or more starting materials and/or the products. Alternatively, or additionally, the reaction control may comprise or consist of the control of the rate of reaction, the composition, size, shape, crystallinity and/or aggregation properties of the product.

The process according to the invention may take place without substantial dissolution of the starting material in the water, where the process proceeds predominantly by leaching of divalent cations and/or Si and/or Al from the starting material.

The reaction requires a CO₂-containing gas stream. Suitably, the CO₂-containing gas stream has a CO₂ concentration of at least 1% v/v, such as at least 8%, at least 12%, at least 20%, at least 40%, at least 50%, at least 75%, at least 90% v/v, at least 95% v/v, or at least 99% v/v. The CO₂ concentration in the reaction may be measured before, during and/or after the reaction by e.g. mass spectrometry (MS) of the gas in a small analysis cell mounted in the reaction vessel or e.g. by monitoring the change in dissolved inorganic carbon (DIC) in the aqueous solution or e.g. by measuring the change in the proportion of carbonate minerals present using X-ray diffraction (XRD).

The CO₂-containing gas stream may originate from a variety of industries, and may e.g. be an off-gas from chemical syntheses, from production of cement, from a flue gas, or biogas, all of which may comprise CO₂. The process may be operated at a pressure of between about 0.5 atm-250 atm, or between 0.5 and 3 atm, preferably around 1 atm.

The CO₂-containing gas stream may be injected into the process throughout substantially the entire reaction time, in an essentially continuous process. In this situation, it is advantageous that the pH in the solution is above 8.3 at standard pressure and temperature and when the dominant cation is Ca (pH would be different at different conditions of temperature, pressure or dominant divalent cation) to precipitate carbonate minerals. pH 8.3 is the pH where calcium carbonate as calcite is stable at standard conditions and low ionic strength. Constant addition of the CO₂-containing gas stream therefore requires a source of base, which can be the starting material until it is used up. Alternatively, a separate source of base may be added in a continuous manner.

Alternatively, the process may be operated as a batch-process. In this situation, the CO₂-containing gas stream may be injected into the process non-continuously.

The reaction requires one or more starting materials selected from waste building material, mineral, rock, sand, amorphous material or combinations thereof; wherein said starting material comprises Si and/or Al, and one or more divalent cation(s). The Si and Al in the starting material are typically in the form of silicate, aluminate or aluminosilicate.

In one aspect, the one or more divalent cation(s) in the starting material(s) are selected from the group consisting of Ca, Mg, Sr, Ba, Fe(II), Mn(II), Ni and Zn. Of these, Ca, Mg and Fe(II) are preferred.

Suitably, the starting material is selected from stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials. Such materials comprise Si and/or Al. In this manner, the process can utilise waste building materials which would otherwise be discarded (e.g., sent to landfill). Waste building materials may also comprise bricks and/or ceramics.

The starting material may alternatively be selected from andesitic, basic or ultrabasic rock; such as basalt, glass or basaltic glass, or sand (silt) or (volcanic) ash or the minerals of andesitic, basic and ultrabasic rocks or combinations thereof.

The pH in the injected carbonated water can come to equilibrium with the basaltic material so that pH is at, or higher than, at least one of the pKas of the organic compound;

In the case where the injection site is basaltic rock, to avoid overpressure in the rock formation, some of the injection water could be taken from the formation, and saturated with CO₂. Organic compounds would be added and the CO₂ containing water would be injected into the formation.

In some cases, the cycle of water from the formation would allow removal of secondary phases in a settling tank or fluidised bed filtering system, to deliver a product comprising:
at least one carbonate mineral and preferably
colloidal silica or alumina or aluminosilicates.
   wherein the starting material is selected from materials in nature, such as one or more of andesitic, basic or ultrabasic rock formations, such as basalt, glass or basaltic glass, or sand or ash or the minerals of andesitic, basic and ultrabasic rocks, particularly where fractures and pore networks offer sufficient surface area or where the sand, soil or ash are fine grained.

The reaction preferably begins with very fine grained material. In this aspect, stone wool is excellent because it is amorphous and its particle size is low. Amorphous materials dissolve more readily than crystalline materials of the same composition and small particles present higher surface area per mass to the solution, thus reacting more rapidly. The stone wool could be a waste product or it could be made-for-purpose, with composition tuned to optimise CO₂ capture and the production of useful reaction products.

The reaction requires water. The water acts as reaction medium, and can solubilise reaction components and transport them to and from the various reaction sites. The water may be fresh water, brackish water, saline water or hypersaline water, preferably fresh water (which is generally considered to have an ionic strength of up to IS=0.1 M). The ionic strength of the water may be between 0.0001 M and 1.0 M. Alternatively, the ionic strength of the water may be between 0.001 mM and 1.0 M.

The pH of the process is suitably maintained at a pH greater than 5.6, such as greater than 7, greater than 8, greater than 8.3, greater than 9, greater than 10 or greater than 11. pH could also be greater than 12 or greater than 13.

The process is suitably operated at a temperature of between 0-100° C., preferably between 25-60° C. If no external heat is available, the process is preferably operated at a temperature between 20-25° C. Rates of reaction generally increase at higher temperature but the solubility of CO₂ decreases with temperature.

In one aspect, the water is saturated with the CO₂ gas during the reaction. The process may therefore involve a step of saturating the water with the CO₂-containing gas stream prior to the reaction.

The reaction requires one or more organic compounds, to control the reaction. When the organic molecule is an organic acid, the pH of the process is maintained at or higher than at least one of the pKas of the organic compound.

The term ‘pKa’ is defined as the −log of the dissociation constant for an acid. For example, the pKa of the carbonic acid dissociation constant can be defined as:

$$pKa = - log \frac{[ {HCO}_{3}^{-} ] [ {H}^{+} ]}{[ {H}_{2} {CO}_{3} ]} = 6.3 .$$

In this way, this pKa defines the pKa for carbonic acid (H₂CO₃) dissociation to bicarbonate (HCO₃⁻).

In the process according to the invention, the organic molecule may have a variety of chemical structures and properties. In one aspect, the organic molecule is a biogenic compound or is synthesised to represent a biogenic compound. The organic molecule is preferably selected from the group consisting of:
a ligand with one or more functional groups, preferably one or more charged or polar functional groups,
a small organic compound,
a complexing agent, such as EDTA or a siderophore,
a polysaccharide,
a polyamine,
   or a mixture thereof.

The small organic compound may be selected from alginate, acetate, adipate, amino acids in their ligand form, ascorbate, aspartate, butrate, catechol, citrate, diglycolate, formate, fumarate, gallate, gluconate, glucosamine, glucose, glucuronate, glutamate, glutarate, glycine, lactate, malate, malonate, mannitol, oxalate, propionate, salicylate, sorbitol, succinate, tartarate, thioglycolate, valerate, 2,4-dihydroxybenzoic acid (2,4-DHBA), or 3,4-dihydroxybenzoic acid (3,4-DHBA). Such compounds are understood to leach or sequester cations during the reaction process.

The biogenic compound may be a complexing agent such as ethylenediaminetetraacetate or 8-hydroxyquinoline; or a siderophore selected from bipyridine or ferritin or ferrichrom or desferrioxamine or bacilibactin or and other siderophores from the classes: catecholates, hydroxamates and carboxylates. Such complexing agents prevent the formation of clays and/or zeolites. This is advantageous because clays and zeolites block the pore networks and steal cations that are needed to form the carbonate minerals, thereby decreasing the extent of CO₂ uptake. For example, a polyamine may be used to sequester Si or a siderophore may be used to sequester Al. This is particularly desirable for the in situ process.

The biogenic compound may be a polyamine selected from putricine, spermidine or spermine or a polyamine, such as a simple polyamine or more complex forms such as may be extracted from diatoms. Such molecules enhance amorphous SiO₂ colloid formation. This is particularly desirable for optimising the product for a pozzolanic effect.

The biogenic compound may be a polysaccharide, such as a simple polysaccharide (i.e. up to 5 saccharides) or very complex, consisting of more saccharide units, including those produced by coccolithophorids, namely coccolith associated polysaccharides (CAP). Such polysaccharides enhance divalent cation-carbonate mineral growth and/or contribute to inhibiting carbonate mineral dissolution. Other polysaccharides include mannose, xylose, rhamnose, galactose, ribose, arabinose, glucose, sucrose, alginate, pectin or xanthan gum. Alternatively, the biogenic compound may be a complex polysaccharide having side chains of mannose, xylose, rhamnose, galactose, ribose, arabinose, glucose, and/or sucrose.

Adsorption properties of the biogenic compounds may be probed using atomic force microscopy (AFM), which allows the observation of adsorption extent and the sites of uptake and to measure the change in surface free energy. The extent of adsorption and the development of the product may also be observed by e.g. X-ray photoelectron spectroscopy to determine the development of the products and their composition at the very early stages, before changes are observable with classical techniques. The removal of material from the starting material surfaces or pore networks or the accumulation of product may be monitored by 3D tomography (e.g. CT scanning), at resolution ranging from macroscopic to the nanometre scale, to evaluate the effect of the geocatalyst (i.e. the organic compound) on the properties of the bulk starting material, dissolution or leaching, and formation of secondary phases. Computational modelling at all scales (density functional theory, molecular dynamics, surface complexation, thermodynamics and kinetics, reactive transport and flow dynamics) can simulate and predict properties and behaviour, complementing the experimental evidence, to test the effectiveness of the biogenic compound and the conditions of their use on very short time scales and providing an optimisation approach that avoids tedious matrix studies.

The change of composition of the starting material may be measured by comparing the elemental composition of the starting material and the elemental composition of the precipitate remaining after the reaction using e.g. X-ray diffraction or X-ray fluorescence spectroscopy or scanning electron microscopy with energy dispersive X-ray spectroscopy and calculations made by geochemical speciation modelling. The reaction products may be tested for particle size using BET surface area analysis or the mineral or particle composition may be determined using e.g. X-ray diffraction or X-ray fluorescence or scanning electron microscopy or polarised light microscopy. The pozzolanic properties of the products may be tested by standard concrete testing protocols.

The process of the invention provides a product comprising:
at least one carbonate mineral and preferably
colloidal silica or alumina or aluminosilicates

The product is a fine-grained material with an average particle diameter of less than or equal to 10 μm, preferably less than 5 μm, and preferably consists of a pozzolanic material. Average particle diameter may be determined by a standard particle analysis method, such as sieving, sedimentation or secondary electron microscopy.

In one aspect, the product can be useful for low CO₂ concrete if it contains clay. The presence of clay is not problematic for an ex situ process. Allowing some clay and not having colloidal silica could make the process much cheaper or faster and would not destroy the possibility of a pozzolanic effect.

In one aspect, at least one of the products is colloidal, amorphous silica. Such colloidal, amorphous silica reacts in the basic conditions of wet concrete to form a calcium silicate phase, often ettringite. Being colloidal, i.e. small, micrometre to nanometre scale, increases its surface free energy, thus making it more reactive.

The at least one carbonate mineral may be selected from the group consisting of CaCO₃, MgCO₃, hydrated MgCO₃, or FeCO₃ or MeCO₃ where Me is another divalent cation selected from the group consisting of Ca, Mg, Sr, Ba, Fe(II), Mn(II), Ni and Zn, or mixtures thereof.

The product may further comprise aluminium oxy(hydrox)oxides, such as aluminium oxides, aluminium hydroxides and/or aluminium oxyhydroxides.

In one aspect of the process, the formation of clays and zeolites is inhibited. For instance, a polyamine may be used to sequester the silica or a siderophore may be used to sequester Al.

In another aspect of the process, clays and zeolites, that had formed previously, are leached or dissolved. “Previously formed” means formed before the process of the invention is carried out.

In another aspect of the process, formation of Al-oxides, Al-oxyhydroxides or Al-hydroxides is promoted.

As an exemplary multiple-step chemical reaction resulting in product formation, carbon dioxide can react with water to produce carbonic acid, which then dissociates to produce carbonate, present in equilibria, as presented below:

CO₂+H₂↔O+H₂CO₃

H₂CO₃↔H⁺+HCO₃⁻

HCO₃⁻↔H⁺+CO₃²⁻

As an example, calcium ions then may be leached, for example, from anorthite (CaAl₂Si₂O₈), which is the Ca bearing end member of plagioclase feldspar minerals (plagioclase feldspar minerals form a solution series ranging from pure albite, NaAlSi₃O₈, to pure anorthite, CaAl₂Si₂O₈). The Ca release is presented below:

CaAl₂Si₂O₈↔Ca²⁺+Al,SiOₓ

Protons may be further consumed during the reaction of the plagioclase feldspar, and when the solution reaches saturation with respect to both CO₃ and Ca, calcite forms as a product:

CO₃²⁻+Ca²⁺↔CaCO₃

Aluminosilicates, aluminium (oxy)(hydr)oxides, clays and zeolites are other common products of feldspar dissolution.

Typically, the biogenic compound increases the reaction rate of the process between the starting material and CO₂, at least by a factor of 2 to 1000 times e.g. 10 to 100 times, or 100 to 1000 times, as measured by cation removal from the starting material. Biogenic compounds can increase (or decrease) rates by 2, 3 or 4 orders of magnitude. Biogenic compounds can stabilise desired minerals or destabilise unwanted phases.

The extent and rate of reaction of the starting material with water, CO₂ and the geocatalyst can be monitored by change in the solution parameters such as temperature, pH, conductivity as well solution composition, analysed using spectrophotometry and/or inductively coupled plasma optical emission spectroscopy (ICP-OES) or mass spectroscopy (ICP-MS). The process may be carried out in-situ, underground or, in or on the ground. In this aspect, the CO₂ containing gas stream is bubbled into water containing the organic molecule(s) described herein, and injected into a rock formation or sand which acts as the starting material.

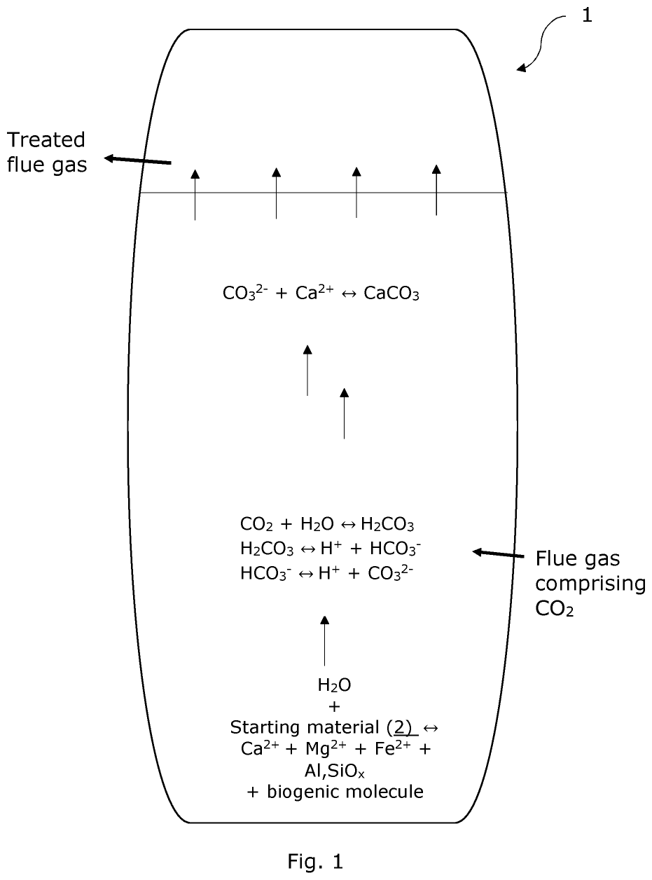

As an alternative, the process may be carried out in a reaction vessel, referred to as ex situ weathering. The general process in a reaction vessel is illustrated schematically in FIG. 1. More specifically, the reaction vessel may comprise a chamber or a scrubber.

The reaction vessel 1 may be any suitable vessel, and may be e.g. lab-scale or factory-scale, e.g. in a reaction chamber or a tower. The size of the reaction vessel may vary, depending on the use and scale needed. For example, a 100 cm³ vessel is suitable for laboratory applications, and 5 m³ or larger chamber is suitable for factory-scale reactors. Suitably, there can be two or more reaction vessels connected in parallel, or in series. The reaction vessel may be continuously operated or intermittently operated. During an intermittent operation, the reaction vessel may be shut down at the end of a reaction cycle when the products are formed and the formed products may be removed. During a continuous operation, the products are continuously removed from the reaction vessel.

The CO₂ stream is introduced into the water, via any conventional inlet means. The CO₂ stream may be introduced via one or more inlets. The CO₂ stream may be e.g. injected, pumped, bubbled or dispersed through a dispersion tube into the reaction vessel.

The CO₂ stream may saturate the water present in the reaction vessel. The CO₂ stream may also be dissolved in water prior to the introduction to the reaction vessel 1 and may be introduced together with the water. Water may also be added to the reaction vessel 1, together with the starting material and the biogenic compound prior to introducing the CO₂ stream.

Preferably, one or more organic compounds and the starting material are placed in the reaction vessel at the beginning of the reaction. The reaction vessel is filled with water. It is preferred that the one or more organic compounds are dissolved in the water prior to carbonation.

At the end of the reaction, the aqueous solution comprising the biogenic compound may be recycled.

Preferably, when two or more reaction vessels are used, the process is first carried out in a first reaction vessel. After this, the water and the one or more organic compound(s) are drained from the first reaction vessel and transferred to a second reaction vessel. A first product is left in the first reaction vessel. Shutting down the first reaction vessel at the end of the first reaction allows the removal of the first product(s).

The process is then carried out in the second reaction vessel in the presence of one or more additional starting materials. In this manner, the aqueous solution, containing the biogenic compounds, can be reused.

Suitably—after removing the water and the one or more organic compound(s) from the first reaction vessel—the first product is removed from the first reaction vessel and the first reaction vessel is charged with fresh starting material.

The water comprising the biogenic compound(s) may be extracted and passed through settling tanks to separate the products from the water with the dissolved biogenic compound(s), then the water and biogenic compound(s) can be refilled in the reactor. In cases where the CO₂ saturated water and biogenic compound(s) are injected in situ, in or on the ground, water can be extracted from the formation, to reduce the pressure in the formation and secondary products that remain suspended in the water can be removed in a settling tank before the water with the biogenic compound(s) is resaturated with CO₂ and reinjected. Such extraction limits the reintroduction of particles into the reaction vessel or in situ, minimising pore blocking of the starting material. The products may be separated from the water using conventional separation methods, such as settling tanks.

The products produced in the process of the invention have various uses. In particular, when the product is pozzolanic, the product produced according to the invention can be used as a replacement for ash in cement production or as a replacement for ash or cement in concrete production. The term “ash” is used to describe-inter alia-fly ash, coal ash, bottom ash, volcanic ash, wood ash and biofuel ash. In cases where the product is not pozzolanic, it can be used as a concrete additive, as a replacement for sand or aggregate.

The product produced in the process is limited to permanent CO₂ capture.

### SPECIFIC EMBODIMENTS

### In Situ Embodiments—for Example, in Nature, a Rock Formation

Specific embodiments relate to geocatalysts and their application to control natural CO₂ capture processes in situ. Within these embodiments, provided is a process for controlling the reaction of:
a CO₂-containing gas stream with
one or more starting materials selected from andesitic, basic or ultrabasic rock; such as basalt, glass or basaltic glass, or sand (silt) or (volcanic) ash or the minerals of andesitic, basic and ultrabasic rocks or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably
colloidal silica,
wherein, the process is carried out in-situ, underground, in or on the ground.

In one preferred embodiment, the process comprises the steps of
providing a starting material, wherein the starting material is selected from andesitic, basic or ultrabasic rock; such as basalt, glass or basaltic glass, or sand (silt) or (volcanic) ash or the minerals of andesitic, basic and ultrabasic rocks or combinations thereof; wherein said starting material comprises Si and/or Al, and one or more divalent cation(s),
providing a CO2 containing stream, wherein the CO2 containing stream is a CO2-containing gas stream optionally dissolved in water, such as being a liquid CO2 containing stream;
providing one or more organic compounds, wherein the one or more organic compounds are selected from one or more geocatalysts,
providing a water stream,
reacting the starting material with the CO2 containing stream and the one or more organic compounds by injecting the CO2 containing stream and one or more organic compounds into the starting material,
wherein at least the CO2 containing stream and/or the one or more organic compound is dissolved in the water stream before reacting with the starting material, and
wherein, the process is carried out in-situ, in or on the ground.

### Starting Material—Choosing an In Situ Site

In situ is defined as in or on the ground. In this embodiment selected starting materials relates to the selection of a site such as an injection site comprising relevant compositions and properties.

The in situ site comprises one or more starting materials selected from mineral, rock, sand, gravel, soil, ash, amorphous material or combinations thereof; wherein said starting material comprises Si and/or Al, and one or more divalent cation(s). More specifically, the starting material is selected from andesitic, basic or ultrabasic rock or their minerals, such as basalt, glass or basaltic glass, or sand or ash.

The in situ site further comprises one or more divalent cation(s). In embodiments, the one or more divalent cation(s) in the starting material(s) is/are selected from the group consisting of Ca, Mg, Sr, Ba, Fe(II), Mn(II), Ni and Zn. Of these, Ca, Mg and Fe(II) are preferred. In this way, starting material at the selected in-situ site comprises one or more divalent cation(s) from the group consisting of Ca, Mg, Sr, Ba, Fe(II), Mn(II), Ni and Zn, preferably Ca, Mg and/or Fe(II).

The composition of the starting material may be characterised by analysing elemental composition of the starting material e.g. X-ray diffraction or X-ray fluorescence spectroscopy or scanning electron microscopy with energy dispersive X-ray spectroscopy

In preferred embodiments, the process may be operated at a pressure of between about 0.5 atm-250 atm, or between 0.5 and 3 atm, preferably around 1 atm. The process is suitably operated at a temperature of between 0-100° C. The starting material dissolves faster at higher temperatures. If no external heat is available, the process is preferably operated at a temperature between 20-25° C. An advantage with this method is that CO2 dissolution is higher at lower temperature. In this way, for specific embodiments in situ sites comprise injection underground at depths of up to 2 or 3 km, where temperature is controlled by the geothermal gradient.

### Injection of CO₂

In a preferred embodiment, the process comprises reacting the starting material with the CO2 containing stream and the one or more organic compounds by injecting the CO2 containing stream and one or more organic compounds into the starting material, wherein at least the CO2 containing stream and/or the one or more organic compound are dissolved in the water stream before injection and reaction with the starting material.

In embodiments, the CO₂ gas stream may be mixed with water and the geocatalyt(s) and injected directly into the natural material formation. Suitably, the CO₂-containing gas stream has a CO₂ concentration of at least 1% v/v, such as at least 8%, at least 12%, at least 20%, at least 40%, at least 50%, at least 75%, at least 90% v/v, at least 95% v/v, or at least 99% v/v, monitored by standard gas analysis. The gas may be injected directly, with water, into the formation. The reaction rate for CO₂ conversion to carbonate is rapid so reaction with surfaces of pores and fractures will raise pH and induce precipitation of the carbonate phases. Addition of geocatalysts aims to keep at least some of the secondary products in suspension so they are pumped out of the formation into settling tanks. This minimises blocking of pore networks and allows the secondary phases to be removed and used.

In one aspect, the water is saturated with the CO₂ gas during simultaneous injection of both phases. In that case, the geocatalyst(s) are added to the water. The water can be formation water, fresh water or sea water. Alternatively or additionally, the process may involve a step of saturating the water with the CO₂-containing gas stream prior to injection. A first way to saturate water with CO₂ comprises filling a tank or any suitable vessel with CO₂ spraying water into the tank. Subsequently, the CO₂ enriched water is injected into the formation. The second way to saturate the water with CO₂ is to bubble the CO₂ into a tank or any suitable vessel filled with water and the CO₂ enriched water is injected into the formation. In both ways, the CO₂ saturated water is provided from the bottom of the tank, because CO₂ saturated water is heavier than water without CO₂ and the geocatalyst(s) are added before or during injection.

The CO₂-containing fluid may be injected into the in situ site throughout the entire reaction time, in a continuous process. Alternatively, the process may be operated as a batch process. In this situation, the CO₂-containing water injection may be pulsed.

CO₂ solubility in water increases as pressure increases. In this embodiment, the depth to the injection location in the injection well define the pressure that must be used. This is well known technology. The depth for injection ranges, depending on the height of the water column (i.e. hydrostatic pressure).

In specific embodiments, a separate source of base may be added to the water in a continuous manner such as to keep the pH of the CO₂-containing gas stream inlet above 5.6. In this way, the pH of the process is suitably maintained at pH greater than 5.6, such as greater than 7, greater than 8, greater than 8.3, greater than 9, greater than 10, greater than 11, greater than 12 or greater than 13. A separate source of base may comprise NaOH, KOH, CaOH, MgOH or water reacted with ash such as fly ash, bottom ash, wood ash, biofuels ash and/or volcanic ash. Hence, in embodiments, ash or the hydroxide compounds may be added to raise pH to 10 or more. High pH enhances solubility of Si, which could leave the formation as colloids, thus enhancing permeability. pH above 8.3 induces mineralisation of CO2 as divalent metal carbonate phases.

In specific embodiments, where the dominant divalent cation is Ca, it can be advantageous that the injection solution reaches the pH and solution composition where calcite and aragonite are saturated. This is pH 8.3 at standard pressure and temperature but the pH threshold would be different at the temperature, pressure and ionic strength of the specific formation solution). High pH and supply of divalent cations is ensured by reaction of the formation materials with the CO₂-containing solution. In specific embodiments, where the dominant cation is Mg, it is advantageous if the formation temperature is around 70° C. or higher, which favours Mg carbonate formation, thus deeper injection wells. Where the dominant cation is Fe(II), it is advantageous to minimise O2 in the CO2 enriched water feed to optimise the mass of cations available for reaction. Some O2 is inevitable but most formation waters, out of contact with air, are reducing.

### One or More Organic Compound—Geocatalysts

In the preferred embodiments, the one or more organic compounds is/are added to the water stream before injection into the formation. This can be before or after addition of CO2, so water cycled through the formation, settling tanks and CO2 saturation tanks can be used and is preferable.

In embodiments, the process comprises one or more organic compounds where the function is catalytic. This means that the geocatalyst is not consumed during this reaction, however the organic compound might be trapped within growing crystals, making it unchanged after the reaction but no longer available for future reaction (until Ostwald ripening releases it again). In the specific embodiments that are in situ, some of the geocatalysts and some of the secondary materials will return with the water cycling but some will inevitably remain underground in the inaccessible pores and fractures.

In embodiments, the organic molecule may have a variety of chemical structures and properties. In one aspect, the organic molecule is a biogenic compound or is synthesised to represent a biogenic compound. In another, it might be a compound that is similar to a biogenic compound.

The organic molecule is preferably selected from the group consisting of:
a ligand with one or more functional groups, preferably one or more charged or polar functional groups,
a small organic compound,
a complexing agent, such as EDTA or a siderophore,
a polysaccharide,
a polyamine,
   or a mixture thereof.

The small organic compound may be selected from alginate, acetate, adipate, amino acids in their ligand form, ascorbate, aspartate, butrate, catechol, citrate, diglycolate, formate, fumarate, gallate, gluconate, glucosamine, glucose, glucuronate, glutamate, glutarate, glycine, lactate, malate, malonate, mannitol, oxalate, propionate, salicylate, sorbitol, succinate, tartarate, thioglycolate, valerate, 2,4-dihydroxybenzoic acid (2,4-DHBA), or 3,4-dihydroxybenzoic acid (3,4-DHBA). Such compounds are understood to leach or sequester cations during the reaction process.

The biogenic compound is a complexing agent such as ethylenediaminetetraacetate or 8-hydroxyquinoline; or a siderophore selected from bipyridine or ferritin or ferrichrom or desferrioxamine or bacilibactin or and other siderophores from the classes: catecholates, hydroxamates and carboxylates. Such complexing agents prevent the formation of clays and/or zeolites. This is advantageous because clays and zeolites block the pore networks and steal cations that are needed to form the carbonate minerals, thereby decreasing the extent of CO₂ uptake. This is particularly desirable for the in situ process, in the pores and fractures of a rock formation. Some of the Ca zeolites are quite soluble so siderophores could help in releasing calcium from zeolites that had already formed in old basalts.

The biogenic compound may be a polyamine selected from putricine, spermidine or spermine or a polyamine, such as a simple polyamine or more complex forms such as may be extracted from diatoms. Such molecules enhance amorphous SiO₂ colloid formation, which is particularly desirable for to enhance the possibility of removing silica colloids from the formation.

The biogenic compound may be a polysaccharide, such as a simple polysaccharide (i.e. up to 5 saccharides) or very complex, consisting of more saccharide units, including those produced by coccolithophorids, namely coccolith associated polysaccharides (CAP). Such polysaccharides enhance divalent cation-carbonate mineral growth and/or contribute to inhibiting carbonate mineral dissolution. Other polysaccharides comprises mannose, xylose, rhamnose, galactose, ribose, arabinose, glucose, sucrose, alginate, pectin or xanthan gum, or a complex polysaccharide having side chains of mannose, xylose, rhamnose, galactose, ribose, arabinose, glucose, and/or sucrose. Complex polysaccharides are effective in enhancing stability of carbonate phases at parts per billion concentration.

As an example of the use of a geocatalyst, a polyamine may be used to sequester the silica or a siderophore may be used to sequester Al. This is advantageous because unavailability of either Si or Al would prevent formation of clays or zeolites (at higher temperature), which block the pore networks and steal cations that are needed to form the carbonate minerals, thereby decreasing the extent of CO₂ uptake. In this way, in one aspect of the process, the formation of clays and zeolites is inhibited.

In another aspect of the process, if silica can be induced to form silica colloids, using polyamines for example, formation of Al-oxides, Al-oxyhydroxides or Al-hydroxides is promoted. This is an advantage if the Al is unavailable for formation of clays and zeolites and Al colloids could leave the formation, settle in tanks and be a useful product.

### Reaction Rates

Typically, a biogenic compound increases the reaction rate of the process between the starting material and CO₂, at least by a factor of 2 to 1000 times, as measured by cation removal from the starting material. Biogenic compounds can increase or decrease rates by 2, 3 or 4 orders of magnitude. Increasing the rate results in an efficient and fast permanent CO₂ capture, in situ. It is sometimes desirable to decrease the rate of reaction, for example close to the injection well, so the CO₂-charged water gets deeper into the formation. A high rate and extensive dissolution directly by the injection site could lead to collapse of the injection well.

The extent and rate of reaction of the starting material with water, CO₂ and the geocatalyst can be monitored by change in the solution parameters such as temperature, pH, conductivity as well solution composition, analysed using spectrophotometry and/or inductively coupled plasma optical emission spectroscopy (ICP-OES) or mass spectroscopy (ICP-MS).

### Product

In the rock formation, at least one carbonate mineral is likely to form, from the group consisting of CaCO₃, MgCO₃, hydrated MgCO₃, or FeCO₃ or MeCO₃ where Me is another divalent cation from the group consisting of Ca, Mg, Sr, Ba, Fe(II), Mn(II), Ni and Zn, or mixtures thereof. The secondary phases may further comprise aluminium oxy(hydrox)oxides, such as aluminium oxides, aluminium hydroxides and/or aluminium oxyhydroxides and colloidal silica. We also expect clays and zeolites to some extent. These phases are likely to form on the pore and fracture surfaces. Some are likely to be carried with the water and may be pumped out of the formation again, where they can be recovered in settling tanks or a fluidized sand filter. Adding geocatalyst(s) can help control which phases form and where they form.

The amount of CO₂ which has reacted in the rock formation may be estimated from the amount of CO₂ injected and the composition of the water and eventual particles that are produced from the formation, using conventional analytical techniques.

### Ex Situ Embodiments—for Example, at a Chimney

Specific embodiments relate to geocatalysts and their application to control natural CO₂ capture processes ex situ. The ex situ process may be in a reaction vessel, chamber, or tower, such as specifically in a scrubber. Within these embodiments, provided is a process for controlling the reaction of:
a CO₂-containing gas stream with
one or more starting materials selected from stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials, such as bricks or ceramics or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably colloidal silica, alumina or aluminosilicate.

In one preferred embodiment, the process comprises the steps of
providing a starting material, wherein the starting material is selected from stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials, such as bricks or ceramics or combinations thereof; wherein said starting material comprises Si and/or Al, and one or more divalent cation(s),
providing a CO2 containing stream, wherein the CO2 containing stream is a CO2-containing gas stream optionally dissolved in water, such as being a liquid CO2 containing stream;
providing one or more organic compounds, wherein the one or more organic compounds are selected from one or more geocatalysts,
providing a water stream,
reacting the starting material with the CO2 containing stream and the one or more organic compounds by injecting the CO2 containing stream and one or more organic compounds into the starting material,
wherein at least the CO2 containing stream and/or the one or more organic compound is dissolved in the water stream before reacting with the starting material.

### Suitable System for Carrying Out the Invention

The process may be carried out in a reaction vessel. The general process is illustrated schematically in FIG. 1. More specifically, the reaction vessel may comprise a chamber or a scrubber.

The reaction vessel may be any suitable vessel, and may be e.g. lab-scale or factory-scale, e.g. in a reaction chamber or a tower. The size of the reaction vessel may vary, depending on the use and scale needed. For example, a 100 cm³ vessel is suitable for laboratory applications, and 5 m³ or larger chamber is suitable for factory-scale reactors. There can be two or more reaction vessels connected in parallel, or in series. In one embodiment, the reaction vessel may be continuously operated and in another embodiment, it can be intermittently operated. During an intermittent operation, the reaction vessel may be shut down at the end of a reaction cycle, when the products are formed, and the formed products may be removed. During continuous operation, the products are continuously added and removed from the reaction vessel.

In a continuous reactor, where new starting material is constantly added and reacted material is removed, the geocatalysts remain with the water. In a dual batch reactor system, the geocatalyst is moved from one reactor to the other, when a new batch is started. Thus the geocatalyst is recycled so much of it is present for the next run.

Preferably, when two or more reaction vessels are used, the process is first carried out in a first reaction vessel. After this, the water containing the geocatalyst is drained from the first reaction vessel and transferred to the second reaction vessel. The first product is then removed from the first vessel, centrifuged, dried and sent to a storage silo. The process is then carried out in the second reaction vessel in the presence of one or more new starting materials. In this manner, the aqueous solution, containing the biogenic compounds, can be recycled.

After removing the water with the geocatalyst(s) and the first product from the first reaction vessel, the first reaction vessel is charged again, with fresh starting material.

### Starting Materials:

The starting material is any basic material (defined as giving pH>7 when exposed to water) that can contribute divalent cations. It also comprises Si and/or Al in the form of silicate, aluminate or aluminosilicate. Preferably, it is fine grained, with a surface area of at least 0.3 m2/g and particle size less than 125 μm. The starting material can be one of, or a combination of stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials, such as bricks or ceramics. It can also include waste building materials. In this manner, the process can utilise waste building materials which would otherwise be discarded (e.g. sent to landfill).

The process provides a fine grained material that is excellent for use in concrete or production of new materials for other applications. In some cases, it is pozzolanic, meaning it can be used as a substitute, at least in part, for cement. In other cases, it is not pozzolanic but it is still a valuable product that can substitute for sand, which is also becoming a limited resource. The product can also be useful for low CO₂ concrete if it contains clay. The presence of clay is not problematic for an ex situ process such as a reactor or scrubber. Allowing some clay and not having colloidal silica could make the process much cheaper or faster and would not destroy the possibility of a pozzolanic effect.

Specifically stone wool and mineral wool are excellent because these materials comprise fibres of large surface area. In addition to exposing higher surface area per mass to the solution, stone and mineral wool are amorphous. Amorphous materials dissolve more readily than crystalline materials of the same composition, thus reacting more rapidly. In this way, the process of controlling the reaction of CO₂-charged solution with a geocatalyst is more rapidly achieved.

In one embodiment, the starting material can be made-for-purpose, as fine fibres that are then crushed. This gives a high surface area, amorphous material, with superb leaching properties, with a composition that can be tailored to the most effective mineralisation of CO2 and secondary phase products that are optimised for particular uses.

It is an advantage to keep the reactor solution as high pH as is reasonable because silicates dissolve and are leached more readily (faster and to greater extent) in basic solutions. Thus an optional class of starting materials includes bases, that can aid in this direction. The starting materials are basic by nature and when exposed to water, will result in a basic pH. However, if necessary, base in the form of NaOH, KOH, CaOH2 or MgOH2 can be added or if available, ash can be added. Ash comprises fly ash, bottom ash, wood ash or biofuels ash or volcanic ash. In addition to raising pH, the process also makes use of materials that would otherwise be disposed of.

The starting materials may be tested for particle size using BET surface area analysis or the mineral or particle composition may be determined using e.g. X-ray diffraction or X-ray fluorescence or scanning electron microscopy or polarised light microscopy and chemical composition using inductively coupled plasma optical emission spectroscopy or spectrophotometry.

Preferably, the starting material(s) are placed in the main reaction vessel at the beginning of the reaction. The reaction vessel is filled with water. It is preferred that the one or more geocatalyst(s) are dissolved in the water of the main reactor.

### Injection of CO2:

The reaction requires a CO₂-containing gas stream. Suitably, the CO₂-containing gas stream has a CO₂ concentration of at least 1% v/v, such as at least 8%, at least 12%, at least 20%, at least 40%, at least 50%, at least 75%, at least 90% v/v, at least 95% v/v, or at least 99% v/v. The CO₂ concentration in the reaction may be measured before, during and/or after the reaction by e.g. mass spectrometry (MS) of the gas in a small analysis cell mounted in the reaction vessel or e.g. by monitoring the change in dissolved inorganic carbon (DIC) in the aqueous solution or e.g. by measuring the change in the proportion of carbonate minerals present in the product using X-ray diffraction (XRD).

The CO₂ stream is introduced into water, via any conventional inlet means. The CO₂ stream may be introduced via one or more inlets. It may be e.g. injected, pumped, bubbled or dispersed through dispersion tubes into the reaction vessel.

In one aspect of the process, water is saturated with CO₂ by passing the flue gas through a tank of water. In another aspect, a tank is filled with CO₂ and water is sprayed into it. In both cases, the CO2 enriched water is collected at the bottom and injected into the reactor. CO2 scrubbers are known technology. Both work. In another, preferable aspect of the process, the CO₂ containing flue gas is injected directly into the main reactor, which is maintained at high pH, to enhance silicate mineral dissolution and so the CO2 is converted quickly to carbonate ions, which react with the dissolved divalent cations in the reactor.

### Temperature and Pressure

The process is suitably operated at a temperature of between 0-100° C., preferably between 25-70° C. If no external heat is available, the process operates at an ambient temperature between 20-25° C. CO₂ dissolves better at lower temperature but silicate minerals dissolve faster and to a greater extent at higher temperature (FIG. 9)

CO₂ solubility in water increases as pressure increases. In this embodiment, the pressure in the reaction chamber, whether for saturation in a separate CO₂ scrubber, or in the main reactor, is slightly above atmospheric. The optimal pressure depends on the height of the water column (i.e. hydrostatic pressure).

### One or More Organic Compound—Geocatalysts

In the preferred embodiments, the one or more organic compounds are added to the water in the main reactor. This can be before or after addition of CO₂.

In embodiments, the process comprises one or more organic compounds where the function is catalytic. This means that the geocatalyst is not consumed during this reaction. However the organic compound might be trapped within growing crystals, making it unchanged after the reaction but no longer available for future reaction (until Ostwald ripening releases it again). In the specific embodiments that are ex situ, in a reactor, the geocatalysts remain with the water. Thus much of it is recycled.

In embodiments, the organic molecule may have a variety of chemical structures and properties. In one aspect, the organic molecule is a biogenic compound or is synthesised to represent a biogenic compound. In another, it might be a compound that is similar to a biogenic compound.

The organic molecule is preferably selected from the group consisting of:
a ligand with one or more functional groups, preferably one or more charged or polar functional groups,
a small organic compound,
a complexing agent, such as EDTA or a siderophore,
a polysaccharide,
a polyamine,
   or a mixture thereof.

The small organic compound may be selected from alignate (i.e. alginate), acetate, adipate, amino acids in their ligand form, ascorbate, aspartate, butrate, catechol, citrate, diglycolate, formate, fumarate, gallate, gluconate, glucosamine, glucose, glucuronate, glutamate, glutarate, glycine, lactate, malate, malonate, mannitol, oxalate, propionate, salicylate, sorbitol, succinate, tartarate, thioglycolate, valerate, 2,4-dihydroxybenzoic acid (2,4-DHBA), or 3,4-dihydroxybenzoic acid (3,4-DHBA). Such compounds are understood to leach or sequester cations during the reaction process.

The biogenic compound is a complexing agent such as ethylenediaminetetraacetate or 8-hydroxyquinoline; or a siderophore selected from bipyridine or ferritin or ferrichrom or desferrioxamine or bacilibactin or and other siderophores from the classes: catecholates, hydroxamates and carboxylates. Such complexing agents prevent the formation of clays. This is advantageous because clays and zeolites steal cations that are needed to form the carbonate minerals, thus decreasing CO₂ uptake efficiency. The presence of clays however, does not risk the value of the secondary phase product.

The biogenic compound may be a polyamine selected from putricine, spermidine or spermine or a polyamine, such as a simple polyamine or more complex forms such as may be extracted from diatoms. Such molecules enhance amorphous SiO₂ colloid formation, which is particularly desirable for to enhance the production of amorphous silica colloids, valued in the pozzolanic product and a good way to inhibit clay formation, thus leaving more divalent cations for carbonate mineral formation.

The biogenic compound may be a polysaccharide, such as a simple polysaccharide (i.e. up to 5 saccharides) or very complex, consisting of more saccharide units, including those produced by coccolithophorids, namely coccolith associated polysaccharides (CAP). Such polysaccharides enhance divalent cation-carbonate mineral growth and/or contribute to inhibiting carbonate mineral dissolution. Other polysaccharides comprises side changes of, mannose, xylose, rhamnose, galactose, ribose, arabinose, glucose, sucrose, alginate, pectin or xanthan gum. Complex polysaccharides are effective in enhancing stability of carbonate phases at parts per billion concentration.

In a preferred embodiment, the one or more organic compound could be a complexing agent such as ethylenediaminetetraacetate or 8-hydroxyquinoline; or a siderophore selected from bipyridine or ferritin or ferrichrom or desferrioxamine or bacilibactin or/and other siderophores from the classes: catecholates, hydroxamates and carboxylates. Such complexing agents sequester Al, preventing formation of clays, thus leaving more divalent cations for carbonate mineral production.

As an example of the use of a geocatalyst, a polyamine may be used to sequester the silica or a siderophore may be used to sequester Al. This is advantageous because unavailability of either Si or Al would prevent formation of clays or zeolites (at higher temperature), which steal cations that are needed to form the carbonate minerals, thereby decreasing the extent of CO₂ uptake.

In another aspect of the process, if silica can be induced to form silica colloids, using polyamines for example, formation of Al-oxides, Al-oxyhydroxides or Al-hydroxides is promoted. It is an advantage if Al is unavailable for formation of clays and Al colloids are a fine component of the final product.

### Reaction Rates

Typically, a biogenic compound increases the reaction rate of the process between the starting material and CO₂, at least by a factor of 2 to 10 times, as measured by cation removal from the starting material. Biogenic compounds can increase or decrease rates by 2, 3 or 4 orders of magnitude. Increasing the rate results in efficient and fast, permanent CO₂ capture in the solid product.

The extent and rate of reaction of the starting material with water, CO₂ and the geocatalyst can be monitored by change in the solution parameters such as temperature, pH, conductivity as well solution composition, analysed using spectrophotometry and/or inductively coupled plasma optical emission spectroscopy (ICP-OES) or mass spectroscopy (ICP-MS).

In one embodiment, the CO₂-containing gas stream is injected into the reactor throughout the entire reaction time, in a continuous stream. In this situation, it is advantageous that the pH in the reactor is maintained in the basic range. For example for calcite, above 8.3 for standard pressure and temperature and when the dominant cation is Ca (pH would be different at different conditions of temperature, pressure or dominant divalent cation) to precipitate the calcium carbonate minerals effectively, thus decreasing their concentration in solution, thus promoting further divalent cation leaching from the solids. In specific embodiments, a separate source of base may be added in a continuous manner, to keep the pH of the solution in the basic range. In this way, the pH of the process is suitably maintained at a pH greater than 5.6, such as greater than 7, greater than 8, greater than 8.3, greater than 9, greater than 10, greater than 11, greater than 12 or greater than 13. A separate source of base may comprise NaOH, KOH, CaOH, MgOH or ash, which may comprise fly ash, bottom ash, wood ash, biofuels ash or volcanic ash. Hence, in embodiments fly ash or other basic compounds may be added to hold pH in the basic range.

### Product

In the reactor, at least one carbonate mineral is likely to form, from the group consisting of CaCO₃, MgCO₃, hydrated MgCO₃, or FeCO₃ or MeCO₃ where Me is another divalent cation from the group consisting of Ca, Mg, Sr, Ba, Fe(II), Mn(II), Ni and Zn, or mixtures thereof. The secondary phases may further comprise aluminium oxy(hydrox)oxides, such as aluminium oxides, aluminium hydroxides and/or aluminium oxyhydroxides and colloidal silica. We also expect protoclays (i.e. primitive clays) and if the temperature is high enough, zeolites might form to some extent. The geocatalyst(s) will control which phases form.

The amount of CO₂ which has reacted is estimated from the amount of CO2 injected, the composition of the water and produced solids and the composition of the gas that is emitted from the reactor, using conventional analytical techniques.

The process comprises a step of centrifuging the solid, removing the water with the biogenic compound from the mineralisation products, recycling the biogenic compound with the water by transferring them to a second main reactor for a subsequent process. The centrifuged product is then dried and transferred to the storage silo.

The products produced in the process of the invention have various uses. In particular, when the product is pozzolanic, the product produced according to the invention can be used as a replacement for ash in cement production or as a replacement for ash or cement in concrete production. The term “ash” is used to describe-inter alia-fly ash, coal ash, bottom ash, volcanic ash, wood ash and biofuel ash. In cases where the product is not pozzolanic, it can be used as a concrete additive, as a replacement for sand or aggregate.

The product is a fine-grained material with an average particle diameter of less than or equal to 10 μm, preferably less than 5 μm, and preferably consists of a pozzolanic material. Average particle diameter may be determined by a standard particle analysis method, such as sieving, sedimentation or secondary electron microscopy.

### Example 1

In Situ—Injection into a Rock Formation

The process is carried out in situ, in the ground, resulting in permanent CO₂ capture.

Water is first saturated with a CO₂ stream, resulting in carbonated water. The biogenic compound(s) are added and the CO₂ saturated water is injected into the rock formation, such as basic or ultrabasic rock, such as basalt, using one or more conventional injection wells. Down gradient, the water, which would contain the geocatalyst and some secondary phase particles, is continuously extracted from the reactive rock formation in order to avoid overpressure during the injection. Some secondary products are typically precipitated within the rock, however some of the products, that follow with the water, are extracted, and can be removed in settling tanks. The biogenic compounds, the geocatalysts, are not consumed during reaction but when the secondary phases crystallise rapidly, some can be incorporated into the growing crystals. Thus, the biogenic compounds that are not incorporated into the products remain in the water and are available for use in the next cycling of the water, which is saturated with CO₂ and injected again, for reaction within the rock formation.

### Example 2

### Ex Situ—Lab Experiment

A reaction vessel (for example, 100 cm³) is provided with ports for adding reaction materials, for extracting samples for chemical and mineral analysis and for monitoring conductivity, DIC (dissolved inorganic carbon) and pH. The starting material, waste stone wool, is placed in the reaction vessel, the vessel is filled with water. 10% or 20% CO₂ is bubbled through the water to saturation. The contents of the vessel are stirred. The biogenic compound(s) are added. The pressure in the reaction vessel is kept at atmospheric pressure. The temperature is at room temperature. After several hours, the product comprises calcite, colloidal silica and remnant starting material and some other phases such as Al oxy (hydr) oxide.

### Example 3A

### Ex Situ—CO2 Trap for Installation at a Factory Chimney

A reactor (for example, 5 m³) is provided, with ports for adding reaction materials, for extracting samples for chemical and mineral analysis and for monitoring solution and solid composition, conductivity, dissolved inorganic carbon and pH. The starting material, waste stone wool for this example, is placed into the reaction vessel, the vessel is filled with water. 10 or 20% CO₂ is bubbled continuously through a gas dispersion plate, from the bottom of the reactor to maintain constant saturation. A propeller near the bottom stirs the solution at a rate just enough to lift the particulate material into the water. The geocatalyst(s) are added. The pressure in the reaction vessel is kept at atmospheric pressure. The temperature is increased from room temperature, preferably 60 degrees C. After several hours, the product comprises calcite, colloidal silica, remnant starting material and some other phases such as Al oxy (hydr) oxide. When the rate of CO₂ uptake begins to decrease, the stirring is stopped and the particles allowed to settle, the water and biogenic compound(s) are transferred to a second reactor, where a new batch of starting material has been inserted. The solids from the first tank are dried by passing the gas stream containing CO₂ through the solids. The gas is subsequently bubbled into the second reactor and the process repeats.

### Example 3b

As above but the water is saturated with CO₂ in a separate tower before injection into the main reactor. The CO₂ flows into a 5 m3 tower. Water is sprayed from the top in a shower. The CO₂ saturated water is extracted from the bottom and injected continuously into the main reactor. The main reactor solution, which contains the geocatalyst(s) is at equilibrium with waste stone wool, i.e. basic, so when the CO₂ saturated water is pumped into the reactor, the CO₂ readily reacts, forming carbonate minerals. Water flows out of the main reactor, is filtered and recycled into the CO₂ tank shower. When the reaction rate slows and the waste stone wool becomes exhausted, the water is transferred into a second reactor and the process repeats. Water is drained from the products, the solids are centrifuged, dried and transported to storage silos.

### EXPERIMENTS

One series of experiments relates to reactions of glass surfaces.

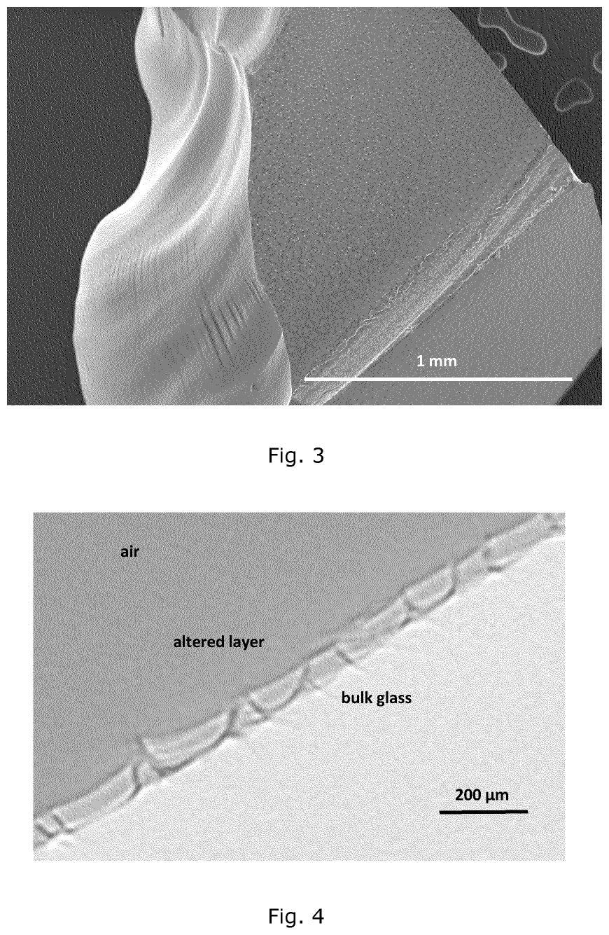

FIG. 3 shows a fresh and reacted glass surface. A scanning electron microscope (SEM) image of a calcium aluminium silicate glass chip, synthesised to contain Ca:Al:Si in a ratio of 1:0.7:1. The chip was exposed to solution at pH 12.5 (NaOH) for 5 months, then fractured just before analysis. The concoidal surface to the left is fresh; that to the right has reacted.

FIG. 4 shows glass alteration. A slice from a 3D tomogram, made using CT scanning at high resolution, showing a chip of calcium aluminium silicate glass (Ca:0.7Al:Si). The glass chip has been exposed to water containing acetate for 5 months. Ca and some Al leach from the surface, forming a layer with lower electron density than the original bulk glass, but higher than the air in contact. As material is removed from the surface, the altered layer contracts, forming cracks that flake off. The cracks allow solution to react with the underlying fresh material, continuing Ca release. The divalent cations are then available for reaction with carbonate, formed by dissolution of CO₂ into the water.

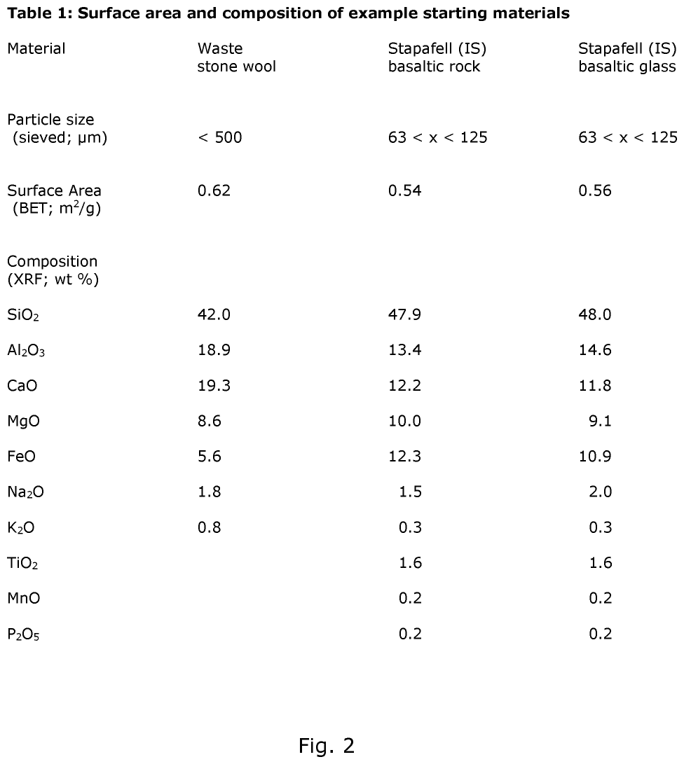

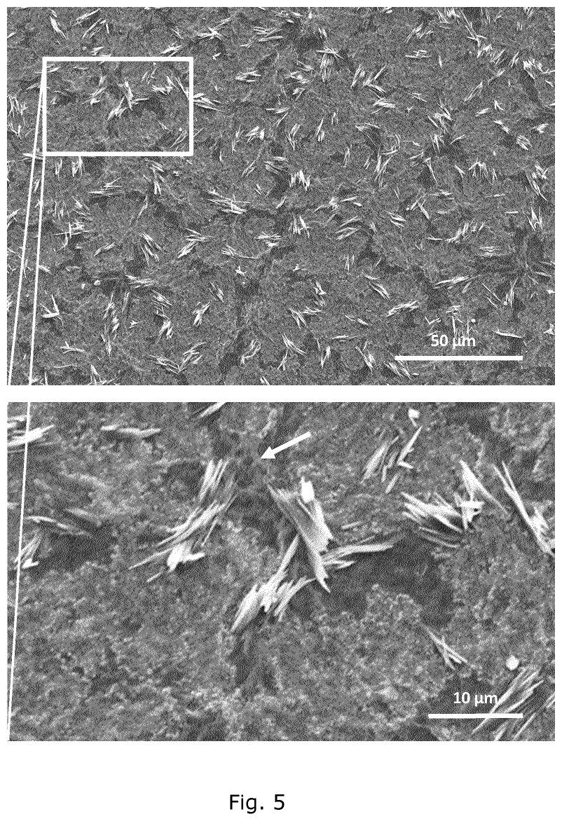

FIG. 5 shows glass reaction at high pH. A scanning electron microscopy (SEM) image of a glass chip (Ca:0.7Al:Si) that has been exposed to water containing only NaOH at pH>12 for 5 months (same as FIG. 2). The polygonal fracture system, caused by loss of mass (predominantly Ca and Al) during leaching, has been overgrown by submicrometre (colloidal) scale granular material (light grey), composed of Al and Si. The needle like bright crystals (white) contain high Na. The low areas in the fractures (darker grey, example shown by white arrow in the enlargement) contain fibrous material, also predominantly Al and Si.

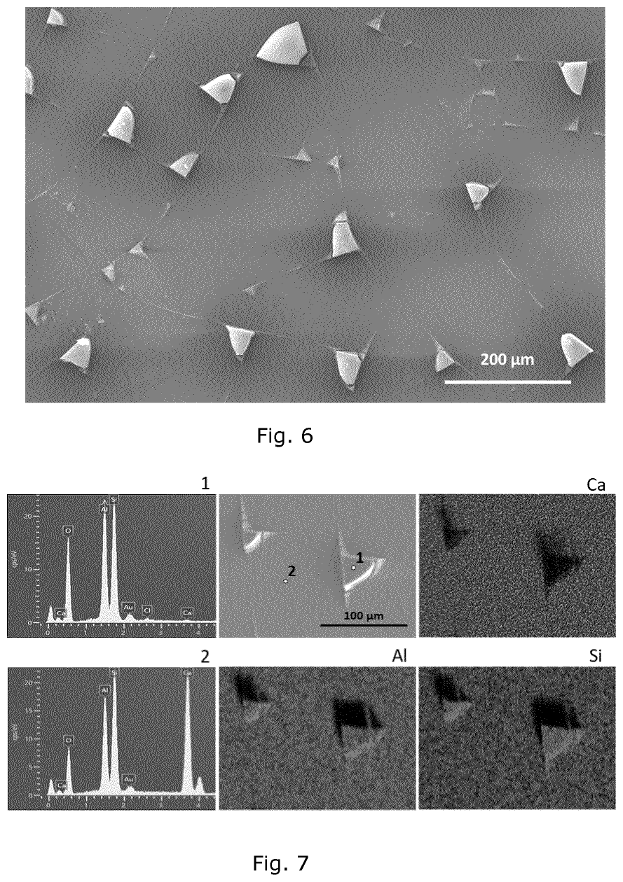

FIG. 6 shows an example of secondary phases. A scanning electron microscopy (SEM) image of the surface of a glass chip exposed to the same conditions as FIG. 4. The polygonal pattern of fractures is visible. The fractures allow water to attack the material beneath the altered later. The brighter material is more dense to the electron beam and forms bumps at the edges and corners of the fractures.

FIG. 7 shows the identity of these secondary phases. SEM with energy dispersive X-ray spectroscopy (EDXS) results. The SEM image in the top middle shows similar accumulations of material. The spectra for Point 1, the accumulated material, shows high Si, Al and O and nearly no Ca whereas the altered material of the surface shows Ca, Al and Si. The chemical maps show the distribution of the elements-Al and Si on the bumps but no Ca. The black shadows on the chemical maps result from the position of the X-ray detector relative to the elevated material.

A second series of experiments relates to reactions of stone wool.

FIG. 2 shows a table comprising surface area and composition of example starting materials, specifically of waste stone wool.

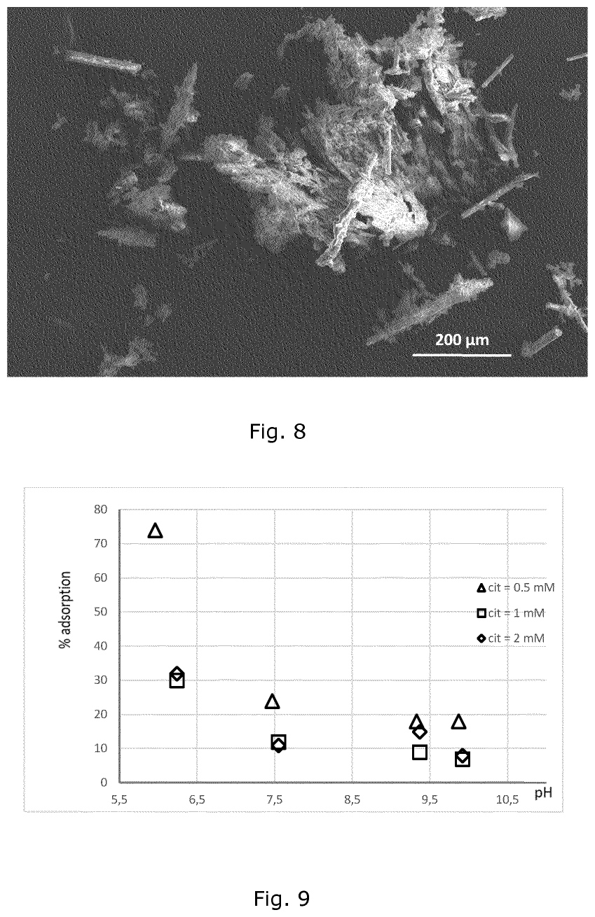

FIG. 8 shows the reaction of stone wool fibres. A scanning electron microscopy (SEM) image of stone wool fibres after exposure to deionised water for 3 weeks. pH increases and secondary phases form on the corroded fibres.

FIG. 9 shows an example of the behaviour of ligands. Ligands adsorb on materials with basaltic composition and the amount varies as a function of pH and the functional groups and configuration of the ligand and surface. Particle surfaces come to equilibrium with the solution and the dissolved organic ligands. A portion of the ligands adsorb on the solid. Some remains adsorbed, inhibiting dissolution. Some leaves again, carrying ions with it from the surface. A portion of the ligands remain in solution, pairing with ions already dissolved, thus lowering their effective concentration (activity), promoting dissolution. The relative proportions involved in each mechanism depend on the free energy relationships of the various components on the solid and in the solution.

In this example, the relative mass of citrate adsorbed on the stone wool particle surfaces is shown as a function of pH. Some of the solid has dissolved so total activity of dissolved Al is 5×10⁻² mM and Ca+Mg is 4×10⁻¹ mM. Experiments were carried out using citrate concentrations of 0.5, 1 and 2 mM. Adsorption was recorded after 5 minutes reaction time.

We see that when citrate concentration is low, a higher proportion adsorbs but once a certain amount is associated with the surface, the rest is in solution. No matter what the initial ligand concentration, the mass of citrate adsorbed on the stone wool surfaces decreases as pH increases, meaning more is active in solution.

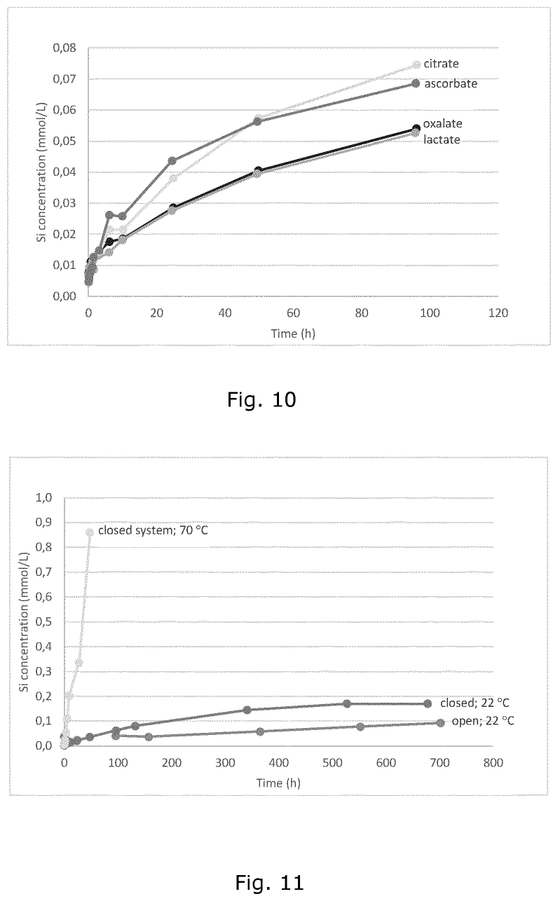

FIG. 10 shows an example of the effect of organic ligands on dissolved silica. Organic compounds control the formation of secondary products. The ligands can be used to change the rate of dissolution or precipitation, as well as to determine particle size and shape. In this example, we see the difference in ability of four simple organic ligands to control Si concentration as stone wool dissolves, at pH 10 (in ammonia buffer). The basic solution is open to air so it pulls in CO₂.

FIG. 11 shows an example of the effect of temperature on silica in solution. Reaction rate and concentration are controlled by temperature. Si is more soluble at elevated temperatures but CO₂ is more soluble in cold water. In this example, stone wool has been exposed to ultradeionised water, in a closed system, at 70° C. and 22° C. For comparison, data for the open system in also included. Out of contact with air, pH increases from around 6 to more than 10, as the stone wool dissolves.

### Aspects

The following numbered aspects are provided:

Aspect 1. A process for controlling the reaction of:
a CO₂-containing gas stream with
one or more starting materials selected from waste building material, mineral, rock, sand, amorphous material or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
   thereby providing a product comprising:
at least one carbonate mineral and preferably
colloidal silica.

Aspect 2. The process according to aspect 1, wherein the reaction comprises mineralization of CO₂.

Aspect 3. The process according to any one of the preceding aspects, wherein the one or more divalent cation(s) is selected from the group consisting of Ca, Mg, Sr, Ba, Fe(II), Mn(II), Ni and Zn.

Aspect 4. The process according to any one of the preceding aspects, wherein the organic compound is a biogenic organic compound.

Aspect 5. The process according to any one of the preceding aspects, wherein the CO2-containing gas stream has a CO₂ concentration of at least 1% v/v, such as at least 8%, at least 12%, at least 20%, at least 30%, at least 40%, at least 50%, at least 75%, at least 90% v/v, at least 95% v/v, or at least 99% v/v.

Aspect 6. The process according to any one of the preceding aspects, wherein the reaction control comprises an increase or decrease in the dissolution rate and/or dissolution extent and/or leaching rate and/or leaching extent of the one or more starting materials and/or the products and/or wherein the reaction control comprises the control of the rate of reaction, the composition, size, shape, crystallinity and/or aggregation properties of the product.

Aspect 7. The process according to any one of the preceding aspects, wherein the process takes place without substantial dissolution of the starting material in the water, where the process proceeds predominantly by leaching of divalent cations and/or Si and/or Al from the starting material.

Aspect 8. The process according to any one of the preceding aspects, wherein the pH of the process is maintained at a pH greater than 5.6, such as greater than 7, greater than 8, greater than 8.3, greater than 9, greater than 10, greater than 11, greater than 12 or greater than 13.

Aspect 9. The process according to any one of the preceding aspects, wherein the organic molecule is a biogenic compound or is synthesised to represent a biogenic compound, and is preferably selected from the group consisting of:
a ligand with one or more functional groups, preferably one or more charged or polar functional groups,
a complexing agent, such as ethylenediaminetetraacetate, or a siderophore,
a small organic compound,
a polysaccharide,
a polyamine,
or a mixture thereof.

Aspect 10. The process according to aspect 9, wherein the biogenic compound is an organic compound such as a small organic compound, such as alginate, acetate, adipate, amino acids in their ligand form, ascorbate, aspartate, butrate, catechol, citrate, diglycolate, formate, fumarate, gallate, gluconate, glucosamine, glucose, glucuronate, glutamate, glutarate, glycine, lactate, malate, malonate, mannitol, oxalate, propionate, salicylate, sorbitol, succinate, tartarate, thioglycolate, valerate, 2,4-dihydroxybenzoic acid (2,4-DHBA), or 3,4-dihydroxybenzoic acid (3,4-DHBA).

Aspect 11. The process according to aspect 9, wherein the biogenic compound is a complexing agent such as ethylenediaminetetraacetate or 8-hydroxyquinoline; or a siderophore, such as ferritin, ferrichrom, desferrioxamine or bacilibactin, bypiridine or and other siderophores from the classes: catecholates, hydroxamates and carboxylates.

Aspect 12. The process according to aspect 9, wherein the biogenic compound is a polyamine selected from putricine, spermidine or spermine; or a polyamine extracted from diatoms.

Aspect 13. The process according to aspect 9, wherein the biogenic compound is a polysaccharide, such as a simple polysaccharide or a complex saccharide, such as those produced by coccolithophorids, namely coccolith associated polysaccharides (CAP), and/or is alginate, pectin, xanthan gum, mannose, xylose, rhamnose, galactose, ribose, arabinose, glucose or sucrose, or a complex polysaccharide having side chains of mannose, xylose, rhamnose, galactose, ribose, arabinose, glucose, and/or sucrose,

Aspect 14. The process according to any one of the preceding aspects, wherein the biogenic compound increases the reaction rate of the process between the starting material and CO₂ at least by a factor of 2 to 10 times, as measured by removal of divalent cation or Si or Al from the starting material.

Aspect 15. The process according to any one of the preceding aspects, wherein the starting material is selected from stone wool, glass wool, mineral wool, waste glass, gypsum panels, gyprock, fibre acoustic panels, fire retardant panels, asbestos panels, waste concrete, cement, mortar, bricks, ceramics or other waste building materials.

Aspect 16. The process according to any one of the preceding aspects, wherein the starting material is selected from andesitic, basic or ultrabasic rock; such as basalt, glass or basaltic glass, or sand or ash or the minerals of andesitic, basic and ultrabasic rocks, or building materials with a composition of andesitic, basic and ultrabasic rocks.

Aspect 17. The process according to any one of the preceding aspects, wherein the process is carried out in a reaction vessel.

Aspect 18. The process according to any one of aspects 1-16, wherein the process is carried out in-situ, in or on the ground.

Aspect 19. The process according to any one of the preceding aspects, wherein the product is a fine-grained material with an average particle diameter of less than or equal to 10 μm, preferably less than 5 μm, and is preferably a pozzolanic material.

Aspect 20. The process according to any one of the preceding aspects, wherein one of the products is colloidal, amorphous silica.

Aspect 21. The process according to any one of the preceding aspects, wherein the formation of clays and zeolites is inhibited.

Aspect 22. The process according to any one of the preceding aspects, wherein clays or zeolites, formed previously, are leached or dissolved.

Aspect 23. The process according to any one of the preceding aspects, wherein one of the products is a carbonate mineral.

Aspect 24. The process according to any one of the preceding aspects, wherein the at least one carbonate mineral is selected from the group consisting of CaCO₃, MgCO₃, hydrated MgCO₃, or FeCO₃ or MeCO₃ where Me is one of the divalent cations listed in aspect 3, or mixtures thereof.

Aspect 25. The process according to any one of the preceding aspects, wherein the water is fresh water, brackish water, saline water or hypersaline water.

Aspect 26. The process according to aspect 25, wherein the ionic strength of the water is between 0.0001 M and 1.0 M.

Aspect 27. The process according to any one of the preceding aspects, wherein the process is operated at a pressure of between about 0.5 atm-250 atm, or between 0.5 and 3 atm, preferably around 1 atm.

Aspect 28. The process according to any one of the preceding aspects, wherein the process operates in CO₂ saturated water with added organic compound(s), injected into underground formations, where the pressure is hydrostatic, to a depth of 3 km or less, preferably 2 km or less.

Aspect 29. The process according to any one of the preceding aspects, wherein the process is operated at the temperature of between 0-100° C., preferably between 20-70° C.

Aspect 30. The process according to any one of the preceding aspects, wherein the process is first carried out in a first reaction vessel, after which the water and the one or more organic compound(s) are drained from the first reaction vessel and transferred to a second reaction vessel, leaving a first product in the first reaction vessel, wherein the process is then carried out in the second reaction vessel in the presence of one or more additional starting materials.

Aspect 31. The process according to aspect 30, wherein—after removing the water and the one or more organic compound(s) from the first reaction vessel—the first product is removed from the first reaction vessel and the first reaction vessel is charged with fresh starting material.

Aspect 32. The process according to any one of the preceding aspects, wherein the process involves a step of saturating the water by the CO₂-containing gas stream prior to the mineralisation reaction.

Aspect 33. The process according to any one of the preceding aspects, wherein the CO₂-containing gas stream is injected into the process throughout substantially the entire reaction time.

Aspect 34. Use of the product produced according to any one of the preceding aspects as a replacement for ash in cement production or as a replacement for ash or cement in concrete production or as a replacement for sand in concrete production.

1. A process for controlling the reaction of: a CO₂ containing gas stream with one or more starting materials selected from stone wool, glass wool, mineral wool, waste glass, gypsum panels, gyprock, fibre acoustic panels, fire retardant panels, asbestos panels, fly ash, bottom ash, wood ash, biofuels ash, waste concrete, cement, mortar, or other building materials, such as bricks or ceramics or combinations thereof; wherein said starting material comprises Si and/or Al, and one or more divalent cation(s), water, and one or more organic compound(s) to control the reaction, provided that when the organic molecule is an organic acid, the pH of the process is maintained at or higher than at least one of the pKas of the organic compound; thereby providing a product comprising: at least one carbonate mineral and preferably colloidal silica.

2. The process according to claim 1, for controlling the reaction of:
a CO₂ containing gas stream with
one or more starting materials selected from stone wool, glass wool, mineral wool, waste glass, gypsum panels, gyprock, fibre acoustic panels, fire retardant panels, or asbestos panels or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably
colloidal silica.

3. The process according to claim 1, wherein said product additionally comprises alumina or aluminosilicate, preferably micro or nanometre scale aluminosilicates.

4. A process for controlling the reaction of:
a CO₂ containing gas stream with
one or more starting materials selected from andesitic, basic or ultrabasic rock; such as basalt, glass or basaltic glass, or sand (silt) or (volcanic) ash or the minerals of andesitic, basic and ultrabasic rocks or combinations thereof; wherein said starting material comprises Si and/or Al, and one or more divalent cation(s),
water, and
one or more organic compound(s) to control the reaction, provided that when the organic molecule is an organic acid, the pH of the process is maintained at or higher than at least one of the pKas of the organic compound;
thereby providing a product comprising:
at least one carbonate mineral and preferably
colloidal silica,
wherein, the process is carried out in-situ, underground, in or on the ground.

5. The process according to claim 1, wherein the reaction comprises mineralization of CO₂.

6. The process according to claim 1, wherein the one or more divalent cation(s) is selected from the group consisting of Ca, Mg, Sr, Ba, Fe(II), Mn(II), Ni and Zn.

7. The process according to claim 1, wherein the reaction control comprises an increase or decrease in the dissolution rate and/or dissolution extent and/or leaching rate and/or leaching extent of the one or more starting materials and/or the products and/or wherein the reaction control comprises the control of the rate of reaction, the composition, size, shape, crystallinity and/or aggregation properties of the product.

8. The process according to claim 1, wherein the process takes place without substantial dissolution of the starting material in the water, where the process proceeds predominantly by leaching of divalent cations and/or Si and/or Al from the starting material.

9. The process according to claim 1, wherein the pH of the process is maintained at a pH greater than 5.6, such as greater than 7, greater than 8, greater than 8.3, greater than 9, greater than 10, greater than 11, greater than 12 or greater than 13.

10. The process according to claim 1, wherein the organic molecule is a biogenic compound or is synthesised to represent a biogenic compound, and is preferably selected from the group consisting of:
a ligand with one or more functional groups, preferably one or more charged or polar functional groups,
a complexing agent such as ethylenediaminetetraacetate or 8-hydroxyquinoline; or a siderophore such as ferritin, ferrichrom, bacilibactin or desferrioxamine or bipyridine or bacilibactin and other siderophores from the classes: catecholates, hydroxamates and earboxylates,
a small organic compound, such as alginate, acetate, adipate, amino acids in their ligand form, ascorbate, aspartate, butrate, catechol, citrate, diglycolate, formate, fumarate, gallate, gluconate, glucosamine, glucose, glucuronate, glutamate, glutarate, glycine, lactate, malate, malonate, mannitol, oxalate, propionate, salicylate, sorbitol, succinate, tartarate, thioglycolate, valerate, 2,4-dihydroxybenzoic acid (2,4-DHBA), or 3,4-dihydroxybenzoic acid (3,4-DHBA),
a polysaccharide, such as a simple polysaccharide or a complex saccharide, such as those produced by coccolithophorids, namely coccolith associated polysaccharides (CAP), and/or is alginate, pectin, xanthan gum, mannose, xylose, rhamnose, galactose, ribose, arabinose, glucose or sucrose, or a complex polysaccharide having side chains of mannose, xylose, rhamnose, galactose, ribose, arabinose, glucose, and/or sucrose,
a polyamine, preferably selected from putricine, spermidine or spermine; or a polyamine extracted from diatoms,
or a mixture thereof,
and preferably wherein the biogenic compound increases the reaction rate of the process between the starting material and CO₂ at least by a factor of 2 to 1000 times, as measured by removal of divalent cation or Si or Al from the starting material,
or wherein the biogenic compound enhances or inhibits the growth of secondary phases, to control the phase composition, size, form and rate of growth of the product.

11. The process according to claim 4, wherein the process is carried out in-situ, in or on the ground, preferably wherein the process operates in CO₂ saturated water with added organic compound(s), injected into underground formations, where the pressure is hydrostatic, to a depth of 3 km or less, preferably 2 km or less.

12. The process according to claim 1, wherein the product is a fine-grained material with an average particle diameter of less than or equal to 10 μm, preferably less than 5 μm, and is preferably a pozzolanic material.

13. The process according to claim 1, wherein one of the products is colloidal, amorphous silica.

14. The process according to claim 1, wherein the formation of clays and zeolites is inhibited, or wherein clays or zeolites, formed previously, are leached or dissolved.

15. The process according to claim 1, wherein one of the products is a carbonate mineral, preferably wherein the at least one carbonate mineral is selected from the group consisting of CaCO₃, MgCO₃, hydrated MgCO₃, or FeCO₃ or MeCO₃ where Me is one of Ca, Ma, Sr, Ba, Re(II), Mn(II), Ni and Z, or mixtures thereof.

16. The process according to claim 1, wherein the process is first carried out in a first reaction vessel, after which the water and the one or more organic compound(s) are drained from the first reaction vessel and transferred to a second reaction vessel, leaving a first product in the first reaction vessel, wherein the process is then carried out in the second reaction vessel in the presence of one or more additional starting materials, and preferably wherein—after removing the water and the one or more organic compound(s) from the first reaction vessel—the first product is removed from the first reaction vessel and the first reaction vessel is charged with fresh starting material.

17. Use of the product produced according to the process of claim 1 as a replacement for ash in cement production or as a replacement for ash or cement in concrete.
